(19) United States
(12) Patent Application Publication
(10) Pub. No.: US 2008/0060152 A1
(43) Pub. Date: Mar. 13, 2008

(54) Culvert cleaner

(76) Inventor: Barry Brungard, Sebastian, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/520,089

(22) Filed: Sep. 13, 2006

(51) Int. Cl. B08B 9/04

(52) U.S. Cl. 15/104.16; 15/104.31

(57) ABSTRACT

Disclosed is an apparatus and method for cleaning pipes, drains, culverts, and similar structures. It is often desired that such structures be cleaned after they have become clogged, or partially clogged, by foreign debris such as sand, dirt, mud, leaves, trash, tree branches, or other foreign material. The apparatus comprises a first lead, a second lead, an insertion pole for inserting the first lead through the structure to be cleaned, and a canister which attaches to the first lead and second lead and is pulled forward and backward through the structure to be cleaned.

The invention is also directed to a method for cleaning a culvert, pipe, drain, or similar structure comprising the steps of inserting a first lead through the structure to be cleaned, attaching the first lead to a canister, attaching a second lead to the canister, and pulling the canister forward and backward through the structure to be cleaned.

### CROSS REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### BACKGROUND OF THE INVENTION

1. Field of the Invention

The present invention is directed to an apparatus for cleaning culverts, pipes, and similar structures.

2. Background

There currently exist a number of mechanisms for the cleaning of pipes, culverts, and similar structures. These mechanisms are typically bulky, heavy, require multiple individuals to operate, are difficult to store, or are difficult to transport, install and operate.

An example of such a system is disclosed in U.S. patent 863,073 to Kuhlman (1907). This U.S. patent discloses a system for cleaning sewers comprised of a multi-part steel gantry, a set of heavy pulleys, and a scraper apparatus. The invention of the '073 is too heavy and bulky for one individual to transport and operate. Furthermore, the size and complexity of the invention of the '073 patent prevents it's use for smaller applications such as to clean culverts underneath a residential driveway and the like and also may require adjustment and maintenance of the track and pulley system. The complexity of the '073 invention is such that it could take a period of days to install, align, maintain, and operate the system.

Another example of an apparatus for cleaning sewers is disclosed in U.S. patent 795,971 to Hanaford (1905). The invention of the '971 patent is an elongated scoop-like device having a closed rear end and having an open mouth and top. This invention exhibits the drawback that it is not efficient for removing debris in a sewer or similar structure that is filled with a significant amount of water. Such water-filled sewers and similar structures are often found in geographical areas where there is significant rainfall such as the southeastern area of the United States, or where a significant rainfall event has occurred such as a hurricane, tropical depression, tropical storm, or other weather system which results in a significant amount of rainfall in a short period of time. Often, the result of such rainfall is that sewers, ditches, drains, culverts, and similar structures fill with water as well as mud and other debris. The invention of the '971 patent is inappropriate for such applications because no provision is made for the draining of water through the closed rear end of the scoop. Thus, water accumulates in the scoop to the point where the scoop is filled, and thereafter the scoop is useless for the removal of debris as the water flowing up and over the sidewall structure of the scoop tends to wash the debris out of the scoop, rendering the scoop ineffective.

Another apparatus for cleaning sewers is disclosed in U.S. patent 402,908 to Donnelly et al. (1889). This U.S. patent discloses a circular ring-shaped knife that is pulled along a sewer to scrape the walls of the sewer clear of clogging debris. This invention does not incorporate a scoop or bucket, and is thus inefficient for the removal debris, especially in a sewer or culvert application in which the structure to be cleaned of debris is filled or partially filled with water.

Yet another device for cleaning a duct, culvert, sewer, or similar structure is disclosed in U.S. Pat. No. 3,882,566 to Hubbell (1975). This U.S. patent discloses a scraper device that is intended to be pulled to through a culvert or similar structure. The shape of the invention is generally open, with no closed end or scoop-like structure. The invention of the '566 patent is inappropriate for use in culverts, pipes, or similar structures that are filled or partially filled with water, as any water residing in the structure to be cleaned will simply wash the collected debris out of the scoop. Furthermore, the invention of the '566 patent is comprised of a shape that is likely to hang or inappropriately drag on the inner wall of culverts that are constructed of corrugated pipe or similar non-smooth wall cross sections.

There is therefore a need for an apparatus which is simple to use, easy to store, is applicable for use in residential applications such as to clean culverts underneath a residential driveways and the like, and efficiently removes debris in situations in which the structure to be cleaned is filled or partially filled with water. There is furthermore a need for a cleaning apparatus that operates efficiently in culverts which are constructed of both smooth and corrugated wall sections.

Additionally, all patents, patent applications and publications discussed or cited herein are incorporated by reference to the same extent as if each individual publication or patent application was specifically and individually set forth in its entirety.

### BRIEF SUMMARY OF THE INVENTION

The present invention overcomes the drawbacks of the aforementioned inventions. An apparatus for cleaning pipes, culverts, and similar structures is disclosed which is simple to use, does not require electrical power or pressured water, is essentially maintenance free, is usable for efficiently removing debris in structures filled or partially filled with water, is inexpensive to produce, and is usable for any structure cross section and for any type of surface, whether the surface of the structure is smooth, corrugated, or some other surface.

The apparatus consists of an insertion pole used to insert a first lead line through the culvert, drain, or similar structure desired to be cleaned such that the first lead line can be attached to a canister for pulling through the structure to be cleaned; a canister that is pulled back and forth through the structure to be cleaned to remove foreign debris including mud, sand, limbs, trash, leaves, and any other clogging debris; and a second lead line used to pull the canister backwards through the structure to be cleaned. The apparatus of the invention can be utilized in culverts, drains, and other structures that are partially or wholly submersed in water, for instance, culverts that have become clogged after flooding due to debris building up and becoming trapped in the culvert.

The invention is also directed to a method of cleaning culverts, pipes, and similar structures comprising the steps of inserting a first lead line through the structure to be cleaned, attaching the first lead line to a canister, attaching a second lead line to the canister for pulling backwards through the structure to be cleaned, and removing debris by alternatingly pulling the canister forwards and backwards through the structure to be cleaned, removing debris until a desired level of cleaning is achieved.

### BRIEF DESCRIPTION OF THE SEVERAL VIEWS OF THE DRAWINGS

FIG. 1 is a view of the step of inserting the insertion pole and lead into a culvert.

FIG. 2 is a view of the insertion pole of the invention.

FIG. 3 is a perspective view of the canister of the invention with leads attached.

FIG. 4 is a detail rear view of the canister of the invention.

FIG. 5 is a view of the step of removing debris by pulling the apparatus through a culvert.

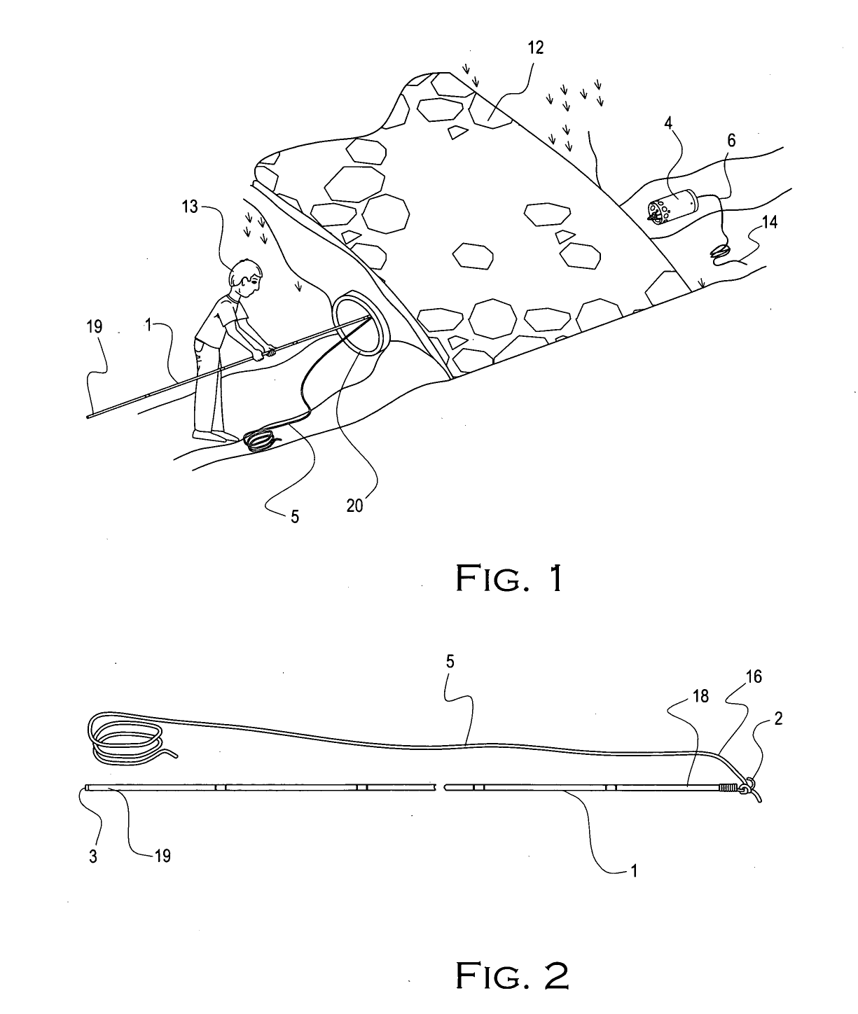

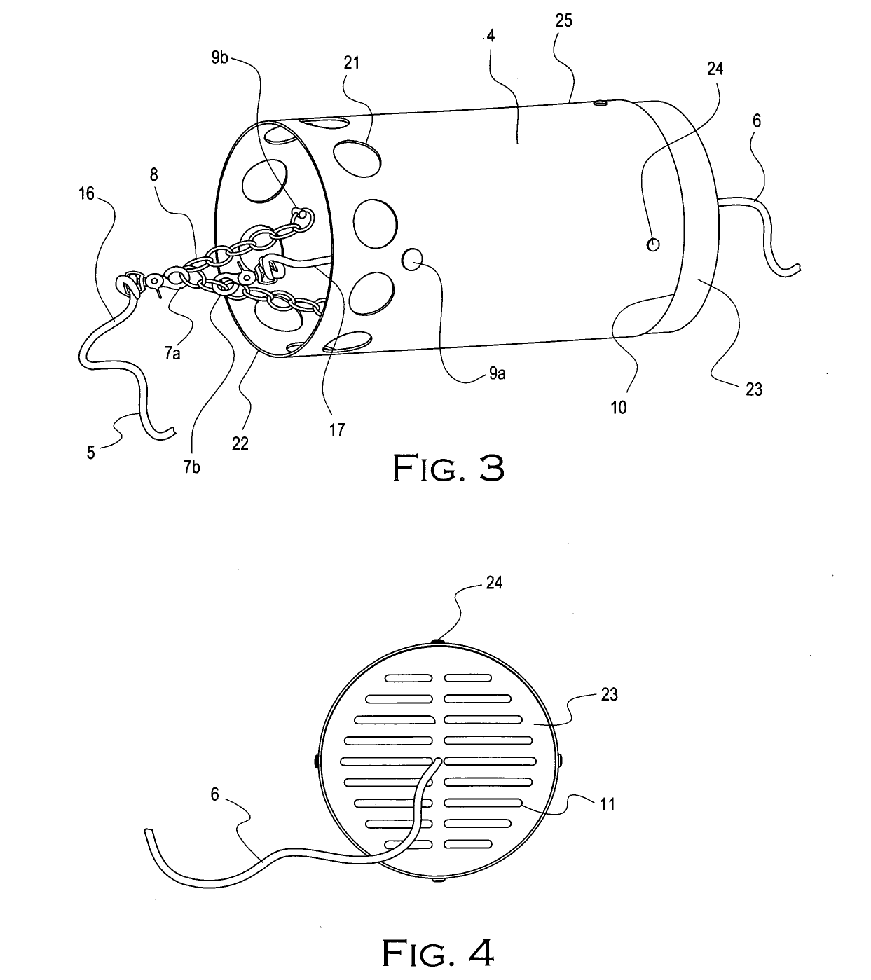

### DETAILED DESCRIPTION OF THE INVENTION

The invention is directed to an apparatus and a method for cleaning a pipe, culvert, drain, or similar structure. Under the scope of the invention, the structure which the apparatus cleans may be any elongate structure.

Referring to the figures of the drawings, the apparatus comprises a first lead 5 having a first end 16 and a second end 15; a second lead 6 having a first end 17 and a second end 14; an insertion pole 1 having a first end 18 and a second end 19; and a canister 4 having a support lanyard 8 attached thereto wherein said support lanyard is attached to inner surface of canister 4 sidewall at attachment points 9a and 9b. Said insertion pole 1 is utilized to push said first end 16 of said first lead 5 through the structure to be cleaned, whereupon said first end 16 of said first lead 5 is disconnected from insertion pole 1 and attached to support lanyard 8 of said canister 4 at attachment 7a, and insertion pole 1 is removed from the structure to be cleaned and set aside.

First lead 5 is fabricated from line, rope, cable, or other flexible material of equivalent structure. Second lead 6 has a first end and a second end and is fabricated from line, rope, cable, or other flexible material of equivalent structure. First lead 5 and second lead 6 are preferably comprised of rope exhibiting a tensile strength of greater than twenty-five pounds and a stretch factor of less than ten per cent when placed under a twenty-five pound tensile load. Alternatively, first lead 5 and second lead 6 may be fabricated from cable fabricated of any material that allows first lead 5 and second lead 6 to be attached to canister 4 and enables canister 4 to be pulled forward and backward through the structure to be cleaned as described in this specification. Such alternate similar materials are commonly used and well known in the art.

Insertion pole 1 is comprised of any material suitable for comprising a rigid pole able to withstand a compression load of greater than ten pounds, but is preferably comprised of fiberglass material of the type normally used in tent poles. Insertion pole 1 may be a single elongate pole, or it may be comprised of a plurality of pole members attached to one another to form a single pole structure. The preferred embodiment of insertion pole 1 is one wherein the pole is comprised of a plurality of pole sections having a hollow core and a sleeve at one end forming a female receiver for receiving the adjacent pole member, each section held together by an elastic member routed through the hollow core of each pole section and attached to the end pole sections. The elastic member is commonly referred to as shock cord. Such poles are commonly used for providing supporting structure in camping tents, are commonly fabricated from fiberglass material, and are well known in the camping art. Alternatively, insertion pole 1 may be fabricated from plastic, high-impact plastic, metal, aluminum, steel, stainless steel, wood, or any other material that enables the pole to be pushed through the debris within the structure to be cleaned. Such alternate materials are well known in the art. Furthermore, insertion pole 1 may be fabricated as a single piece.

The preferred embodiment of insertion pole 1 described above, namely, the multi-section pole assembly comprised of a plurality of pole members held together by an elastic member passing through the hollow core of each pole member, allows for easy break-down, storage, and shipping of the apparatus.

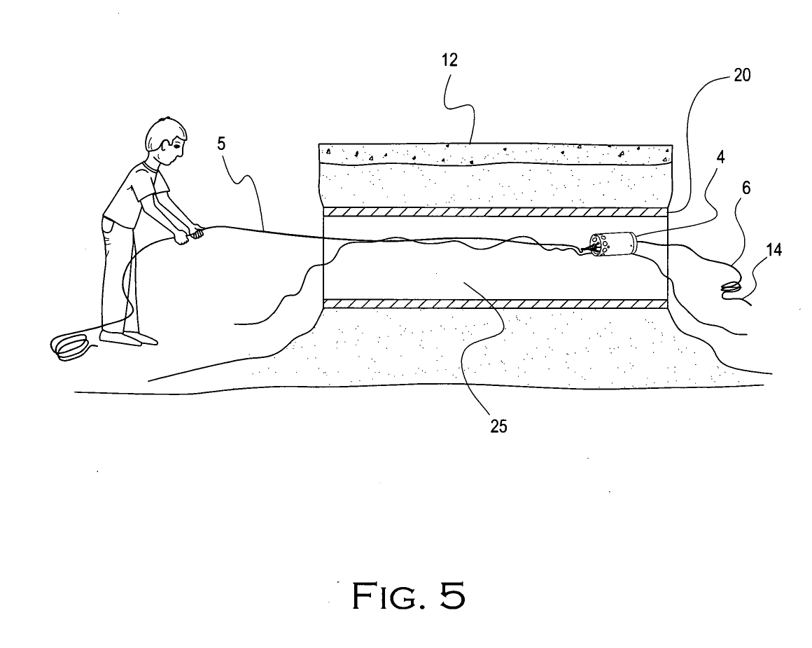

Canister 4 is depicted in FIG. 3 and FIG. 4. Referring to FIG. 3 and FIG. 4, canister 4 is comprised of an open-cross section tubular shape which may be square, rectangular, circular, or any open cross section shape, and wherein a continuous sidewall 25 exists having an inner and an outer surface. Furthermore, canister 4 has a first end 22 and a second end 10 as shown in FIG. 3. A preferred embodiment of canister 4 is shown in FIG. 3 and is circular in cross section. The preferred circular cross section canister shape enables canister 4 to be easily fabricated from common pipe materials that are readily available. Canister 4 is preferably further comprised of a plurality of openings 21 in said canister sidewall extending around the circumference in proximity to first end 22, allowing small debris such as sand, mud, or water, to pass through the openings 21 and allow canister 4 to be more easily pulled through the structure to be cleaned. Said openings 21 are located in said canister 4 preferably in proximity to said first end 22, but may be placed in any pattern and in any location on said canister 4. However, openings 21 are not essential to the invention, and thus an alternate embodiment of canister 4 is one wherein openings 21 are not present. Canister 4 is further comprised of a closed end plate 23 attached to second end 10 of canister 4 by any attaching means including but not limited to chemical bonding, mechanical press fit, a plurality of rivets, or a plurality screws 24 extending through the sidewall of canister 4, said plurality of screws 24 threadingly engaged in end plate 23. End plate 23 is fabricated from a material of sufficient strength so as not to buckle or bend when the canister is filled with debris material to be removed from the structure to be cleaned, when first lead 5 is placed in tension and canister 4 is pulled through the structure. End plate 23 may be fabricated from one of the materials selected from the group consisting of plastic, high-impact plastic, carbon-filled plastic, fiberglass, aluminum, steel, stainless steel, or any other metal; however, a number of materials suitable for use in fabricating end plate 23 are readily conceived by one skilled in the art and the invention is thus not limited by the materials listed in this disclosure. End plate 23 is further comprised of a plurality of openings 11 of any shape and number. The shape of openings 11 is not essential to the invention and may be oblong, circular, square, rectangular, or any other shape. The plurality of openings 11 allow sand, mud, water, and similar material to pass through the canister by allowing such material to pass through end plate 23 as canister 4 is pulled in the forward direction through the structure to be cleaned. In this manner, canister 4 may be pulled through the structure to be cleaned with less effort than if openings 11 were not present. The plurality of openings 11 is not essential to the invention, and thus the invention may be realized without openings 11 as an alternate embodiment of the invention.

Canister 4 is further comprised of a support lanyard 8 having a first end and a second end, said support lanyard attached to said inner surface of said sidewall of canister 4 at attachment points 9a and 9b as shown in FIG. 3. Support lanyard 8 may be fabricated from any flexible material such as metal chain, metal cable, rope, or other flexible material known in the art with a tensile strength of greater than twenty-five pounds. The first and second ends of support lanyard 8 are attached to the inside surface of canister 4 at attachment points 9a and 9b, one attachment point for each end of support lanyard. Attachment points 9a and 9b may be realized by utilizing attachment means as is known in the art for the attachment of chains and ropes to a wall section. An exemplary attachment means is accomplished by pressing a pin member through the sidewall of canister 4 at each of attachment points 9a and 9b, said pin member having a hole for accepting an end of support lanyard 8, as shown in FIG. 3 of the drawings. The first end of support lanyard 8 is then attached to the pin member at attachment point 9a and the second end of support lanyard 8 is attached to the pin member at attachment point 9b. While this exemplary method is described herein, alternate embodiments for attaching the first and second ends of support lanyard 8 to sidewall of canister 4 exist and are known in the art, and are within the scope of the invention.

The first end of first lead 5 is removeably attached to support lanyard 8 by attachment means 7a which is selected from a number of attachment means known in the art. Exemplary attachment means for accomplishing attaching means 7a are tying and snap shackle. Said first end of second lead 6 is attached to support lanyard 8 by attachment means 7b which is selected from a number of attachment means well known in the art. The attaching means 7b may be any suitable attaching means known in the art: exemplary attachment means include tying, crimp sleeve, whipping, or snap shackle. A snap shackle attachment means is shown as 7a and 7b in FIG. 3 and is the preferred embodiment of the invention, because snap shackle attachment allows for quick set-up and break down of the invention. Referring to FIG. 3, item 7a shows a snap shackle attachment means attaching the first end of first lead 5 to support lanyard 8, and item 7b shows a snap shackle attachment means attaching first end of second lead 6 to support lanyard 8.

Once the first end 16 of first lead 5 is attached to support lanyard 8 by any of the means disclosed, and the first end of second lead 6 is attached to support lanyard 8 by any of the means disclosed, it is apparent that the canister may be pulled forward and backward through the structure to be cleaned.

Referring to FIG. 5, the invention is typically used to clean a culvert 20 such as is commonly placed under a driveway 12. To use the invention, the first end 16 of first lead 5 is attached to the first end 18 of insertion pole 1. The first end 17 of second lead 6 is attached to attachment point 7b of canister 4 by first passing second lead 6 through one of the openings of the plurality of openings 11 in canister end plate 10. Referring to FIG. 1, a user of the invention 13 inserts insertion pole 1 through the structure to be cleaned by pushing insertion pole 1 through the debris, water, mud, or other material present in the structure to be cleaned. After insertion pole 1 has been inserted through the structure to be cleaned 20 exposing first end 18 of insertion pole 1 on the far side of the structure, the first end 16 of first lead 5 is removed from insertion pole 1 and is attached to attachment point 7a of support lanyard 8. The first end of second lead 6 is attached to attachment point 7b of support lanyard 8. Insertion pole 1 is removed from the structure to be cleaned and set aside. The canister 4 is then pulled forward through the structure to be cleaned 20, capturing and removing debris 25 as it is pulled forward. After pulling forward, the canister 4 is emptied of debris, canister 4 is pulled backward through the structure to be cleaned 20 by pulling second lead 6. In this manner canister 4 is pulled forward and backward through the structure to be cleaned 20 until the desired amount of foreign debris has been removed from the structure.

FIG. 1 depicts a typical structure as the culvert 20 underneath a driveway 12, however the structure to be cleaned may be any pipe, culvert, drain, or similar structure. The breadth and scope of the invention is not limited to use only for pipes, drains, or culverts. It is obvious that the invention is usable for many applications and structures not specifically described in the disclosure of the invention.

The invention is also directed to a method for cleaning culverts, pipes, drains, or similar structures comprising the steps of attaching a first lead to an insertion pole; pushing said insertion pole through a culvert, pipe, or similar structure desired to be cleaned; removing first lead and attaching first lead to a canister; attaching a second lead to said canister; pulling canister in a forward direction through the structure to be cleaned by pulling on said first lead; pulling canister in a backward direction by pulling on said second lead; and repetitiously pulling on first and second lead to pull said canister backward and forward to remove the desired amount of debris material from the structure to be cleaned.

While particular embodiments of the apparatus and method of the invention have been described, it is obvious that numerous other embodiments of the invention may be realized by one skilled in the mechanical arts, without departure from the spirit and gist of the invention.

I claim:

1. An apparatus for cleaning culverts, pipes, and the like, comprising:
a first lead having an first end and a second end;
a second lead having a first end and a second end;
an insertion pole having a first end and a second end;
a canister having a continuous sidewall forming a enclosed shape of elongate proportions wherein said continuous sidewall forms an inner and an outer surface, a first end, and a second end, further comprising:
an end plate enclosing said canister second end and attached to said canister second end by a first attachment means, said end plate having a plurality of openings; and
a support lanyard having a first end and a second end;
wherein said first end of said support lanyard is attached to said inner surface of said canister sidewall at a first attachment point by a second attachment means, and wherein said second end of said support lanyard is attached to said inner surface of said canister sidewall at a second attachment point by a third attachment means, wherein said first attachment point and said second attachment point are approximately diametrically opposed on said inner surface of said sidewall; and
wherein said first end of said first lead is removeably attached to said first end of said insertion pole by a fourth attachment means; and
wherein said first end of said second lead passes through said opening of said canister end plate and is attached to said support lanyard by a fifth attachment means.

2. The apparatus of claim 1, wherein:
said first attachment means is selected from the group consisting of chemical bonding, mechanical press fit, rivets, and screws passing through clearance openings in said sidewall of said canister and threadingly engaging said end plate; and
said fourth attachment means is selected from the group consisting of tying and snap shackle; and
said fifth attachment means is selected from the group consisting of tying, whipping, crimp sleeve, and snap shackle.

3. The apparatus of claim 1, wherein said canister is circular in cross section.

4. The apparatus of claim 2, wherein said canister is circular in cross section.

5. The apparatus of claim 1, further comprising a plurality of openings through said canister sidewall, said openings placed circumferentially around canister and in proximity to said canister first end.

6. The apparatus of claim 2, further comprising a plurality of openings through said canister sidewall, said openings placed circumferentially around canister and in proximity to said canister first end.

7. The apparatus of claim 3, further comprising a plurality of openings through said canister sidewall, said openings placed circumferentially around canister and in proximity to said canister first end.

8. The apparatus of claim 4, further comprising a plurality of openings through said canister sidewall, said openings placed circumferentially around canister and in proximity to said canister first end.

9. A method for cleaning pipes, culverts, drains, and the like, comprising the steps of:
attaching a first lead to a first end of an insertion pole;
pushing said first end of said insertion pole through a culvert, pipe, or similar structure desired to be cleaned;
removing said first lead from said first end of insertion pole, attaching said first lead to a canister;
attaching a second lead to said canister;
removing debris from the structure to be cleaned by pulling said canister in a forward direction through the structure to be cleaned by pulling on said first lead;
pulling said canister in a backward direction by pulling on said second lead; and
repetitiously removing debris from the structure to be cleaned by pulling on said first lead, followed by pulling on said second lead, to move said canister forward and backward through the structure to be cleaned, until the desired amount of debris material from the structure to be cleaned has been removed.
